(19) United States
(12) Patent Application Publication
(10) Pub. No.: US 2023/0185040 A1
(43) Pub. Date: Jun. 15, 2023

(54) ACTIVE OPTICAL CABLES WITH INTEGRATED INFRARED REMOTE CONTROL CAPABILITIES

(71) Applicants: Luca Zanetti, Orlando, FL (US); Silvia Fioravanti, Orlando, FL (US)

(72) Inventors: Luca Zanetti, Orlando, FL (US); Silvia Fioravanti, Orlando, FL (US)

(21) Appl. No.: 18/071,546

(22) Filed: Nov. 29, 2022

Related U.S. Application Data
(63) Continuation-in-part of application No. 16/743,412, filed on Jan. 15, 2020, now Pat. No. 11,543,607.

(51) Int. Cl. G02B 6/44; G02B 6/10; G02B 6/42

(52) U.S. Cl. CPC G02B 6/4416; G02B 6/102; G02B 6/443; G02B 6/4277; G02B 6/4293

(57) ABSTRACT

Infrared Remote Over Video Fiber (IROVF) transports any combination of uncompressed/unprocessed/native full quality, full bandwidth, zero latency, and mixed analog and digital signals including audio, video, data, Ethernet, USB, S/PDIF, and TOSLINK, over a fiber optic based cable added with integrated infrared remote control capabilities to remote control uni/bi-directional audio video and IR devices remotely from either sides of the cable Without requiring additional processing adapters, nor processing or reducing the specs of the other carried audio-video data signals which stays original uncompressed, untouched, and unprocessed for a perfect as-is full original functionality and quality.

### CROSS-REFERENCE TO RELATED APPLICATIONS

This application is a continuation-in-part of a U.S. patent application Ser. No. 16/743,412, filed on Jan. 15, 2020, which is incorporated herein by reference in its entirety

### FIELD OF INVENTION

The present invention relates to a fiber-optic cables, and more particularly, the resent invention relates to an Infrared Remote Over Video Fiber (IROVF) that can transport infrared unidirectional and/or bi-directional infrared remote-control commands together with unprocessed and uncompressed audio, video, USB, ethernet, TOSLINK, and data signals in single or multiple mixed combinations.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, disclosed is an infrared remote over video fiber (IROVF) that allows transporting any combination of uncompressed/unprocessed/native full quality, full bandwidth, and zero latency mixed, analog, and digital signals including audio-video data, ethernet, USB, S/PDIF, and TOSLINK over a fiber-optic cable, also referred to herein as active optical cable (AOC), added with integrated infrared remote control capabilities to remote control unidirectional and bidirectional audio-video and IR devices remotely from both sides of the cable.

In one aspect, disclose is a fiber with infrared mechanism integrated to AOC cables, as well the combination of one or more audio, video, data, ethernet, USB, and TOSLINK uncompressed, unprocessed, and zero lag signals within the same AOC cable added with infrared and/or serial remote control.

In one aspect, disclosed is a fiber cable that can also integrate mechanisms other than infrared for remote controlling a range of multimedia devices and peripherals. The disclosed cable can provide for home automation, wherein different devices can be controlled from anywhere in the home, wherein the commands/control signals for operating the devices can be transmitted through the disclosed cable.

In one aspect, the disclosed cable integrates audio return channel, such as ARC/eARC, which can be used with the remote control. For ARC/eARC, suitable strands, such as copper, fiber, or silver, straight or twisted can be provided. Preferably, the disclosed cable can integrate two conductors for the audio return channel that can support Dolby® and the AV receiver can drive a loudspeaker. Preferably, the audio return channel can be transmitted through optical fiber.

In one aspect, disclosed cable can transmit commands for operating Wi-Fi devices, alarms, cameras, lights, HVAC systems, curtain motors, triggers, RS232/495, and similar devices.

In one aspect, the disclosed cable can integrate an AES/EBU channel, XLR channel, S/PDIF channel, and/or AUX channel.

In one aspect, the disclosed cable can support commands/signals for USB-USB-C extension and/or KVM commands by integrating additional copper strands, silver stands, Fiber strands, or combinations thereof.

In one aspect, the disclosed cable can integrate a combination of fiber and copper for HDMI video and ETHERNET commands controls between the source and display side of the cable.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a cross-sectional view of an Infrared Remote Over Video Fiber (IROVF), according to an exemplary embodiment of the present invention.

FIG. 2 is a schematic view of the IROVF of FIG. 1, according to an exemplary embodiment of the present invention.

FIG. 3 is a cross-sectional view of an implementation of the IROVF, according to an exemplary embodiment of the present invention.

FIG. 4. is a schematic view of the IROVF shown in FIG. 3, according to an exemplary embodiment of the present invention.

FIG. 5 is a cross-sectional view of an implementation of the IROVF, according to an exemplary embodiment of the present invention.

FIG. 6 is a schematic view of the IROVF shown in FIG. 5, according to an exemplary embodiment of the present invention.

FIG. 7 is a schematic view of an implementation of the IROVF, according to an exemplary embodiment of the present invention.

FIG. 8 is a cross-sectional view of the IROVF shown in FIG. 7, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a cable i.e., Infrared Remote Over Video Fiber (IROVF) that can connect and distribute uncompressed/unprocessed/native full quality, full bandwidth, and zero latency The disclosed IROVF can also integrate mechanisms other than infrared for remote controlling a range of multimedia devices and peripherals. The disclosed IROVF can provide for home automation, wherein different devices can be controlled from anywhere in the home, wherein the commands/control signals for operating the devices can be transmitted through the disclosed IROVF. The disclosed IROVF can be made compatible with a range of electronic devices including camera, HVAC system, curtain motors, lights, and the like devices. The different devices may have different standards and commands, the disclosed IROVF can be adapted to such different device. It is also an object of the present invention to eliminate the need for multiple remote devices for different devices at home.

In certain implementations, the disclosed IROVF can also suggests a guideline about how the fiber optic-based cable can be realized as well suggests a main color coding for the wires to standardize the connections across multiple IROVF licensed manufacturers of both cables and connectors.

IROVF can also be defined as a standard to build the next generation audio-video data and to control uncompressed AOC based multimedia extender cable solutions, including HDMI AOC extenders, SDI AOC extenders, USB AOC extenders, Ethernet AOC extenders, Gaming AOC extenders, and the like.

An object of the present invention is to evolve from the huge limits of a typical home & commercial audio-video data wiring based over Cat-5, Cat-6, Cat-7, Cat-8, and Cat-x twisted pairs cables which cannot distribute the modern 4K or 8K uncompressed 18 gigabit or 48 gigabit video signals, nor cannot distribute multiple audio-video ethernet signals all together to each room or location over the same Cat-x cable without using processing extenders which require extra power supplies and introduces a lag with substantial loss of quality and speed by using a compression processing mechanism, to a modern, more convenient, simpler, and cost effective slim cable solution (the IROVF STANDARD CABLE) which transports uncompressed, unprocessed, full bandwidth, full quality original audio-video data, ethernet, and TOSLINK signals to each room and location having the same IROVF slim cable together with a full featured unidirectional or bidirectional infrared/serial remote control system which allows the remote control of audio-video automation and any IR or serial device from both sides of the cable.

An object of the present invention is to simplify the audio video multimedia distribution in homes, commercial, professional, military, educational, medical, and any other installation, improving security, and environmental health as IRVOF does not requires additional external signal processor box, converters, and extenders which have their own power supplies resulting in additional energy consumption and additional environmental pollution in a long term.

To achieve these goals, the IROVF cable is connected at both sides to specific audio-video data and infrared connectors, directly or through sub connectors.

Each audio-video, ethernet, USB, and TOSLINK data connector can be added or integrated with an infrared electric block.

The infrared blocks can receive and transmit to each other the commands captured and emitted in the rooms via IR EYES transmitters and receivers sensors connected to the IR blocks.

The IR EYES can receive and/or transmit IR commands from IR remote controls such as TV remote controls, home automation controls, control tablets and phones, programmable IR remote controls to audio-video TV systems and any IR controllable devices.

The IR EYES can be integrated directly on the AOC based cable connectors housing shells and/or IR blocks housing shells of the fiber-based AOC cable.

The IR EYES can also be separate parts with a wire connected to the main fiber-based cable or directly on the main AOC connector housing via pluggable connectors such as a 3.5 mm jack or any other, where these pluggable IR ports can be installed and integrated directly inside the AOC based cable connector housing shell, or floating connectors from the cable.

The IR EYES might also be already connected/wired to each side of the main AOC based cable or AOC main connector.

An IR EYE Receiver can be typically installed via an adhesive in front of the viewing TV, so the IR EYE can see, and capture command coming from an IR remote control(s) and send the command to the other side of the fiber-optic-based AOC cable reproducing them through the IR-EYE transmitter in front of the remote controllable destination(s), controlling it.

Some TV sets also provide a plug-in jack on the rear TV connections to use the TV IR EYE built-in into the TV in place of installing another adhesive IR eye in front of the TV, usually on the TV bezel. In this case, the TV IR EYE jack can be connected directly to the IR block so the IR commands will be captured and delivered to the other side of the AOC -based cable directly from the IR EYE built into the TV.

The Copper and/or fiber optic infrared audio-video, ethernet, USB and TOSLINK cables, connectors and mechanism herein described can also be added with additional data connections and connectors, such as ethernet, serial, audio, video, data, TOSLINK, S/PDIF, SDI video, multiple SDI video up to 8 k and higher, AES/EBU, composite video, component video, and any other audio-video data connection, to create an infrared cable and mechanism with multiple multi-standard connections and combination, so the infrared mechanism will be able not only to the remote control and remote multimedia devices from each-other sides of the IROVF cable, but as well other different non-multimedia devices, while the IR integrated multi standard cable will offer multiple types of connection at once with the IR control feature.

By replacing the IR sensors with different source and destination devices, the invention allows the connection between any serial data communication devices within the same AOC cable, without disrupting, using, or reducing the audio, video, ethernet, USB, and TOSLINK connection full standard and functionality (any type), without requiring additional external adapters converters, repeaters, or external additional cables.

The connectors (or end points or terminations) of the IROVF can be created and organized independently one by one, or in a IROVF strip or in an IROVF wall plate with keystones.

For the standalone single connectors, the connectors might take their sub wires directly from the main IROVF cable in an “octopus style” or from the main video connector as a “pass-through” mechanical design. This is anyway not limiting the possibilities to construct and wire the IROVF mechanism/invention in any possible mechanical or electrical way, where the main key invention remains the fact that there is an infrared command mechanism integrated with an unprocessed uncompressed audio/video link over copper and/or fiber-based cable.

The IROVF suggests three main types of cables layouts. IROVF suggests a guideline to realize three types of fiber-based AOC cables:
TYPE 1: IROVF-LT application: video distribution+IR remote control,
TYPE 2: IROVF-LTE application: IPTV/APP TELEVISION+in-room audio+video distribution+IR remote control,
TYPE 3: IROVF-LTX application: ZERO-LAG Gaming+IPTV/APP TELEVISION+in room audio+video distribution+auxiliary controls & home automation/security+IR remote control.

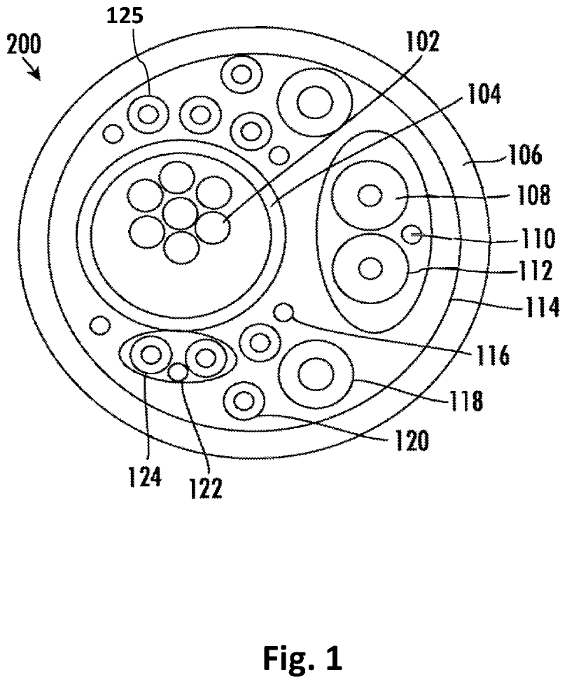

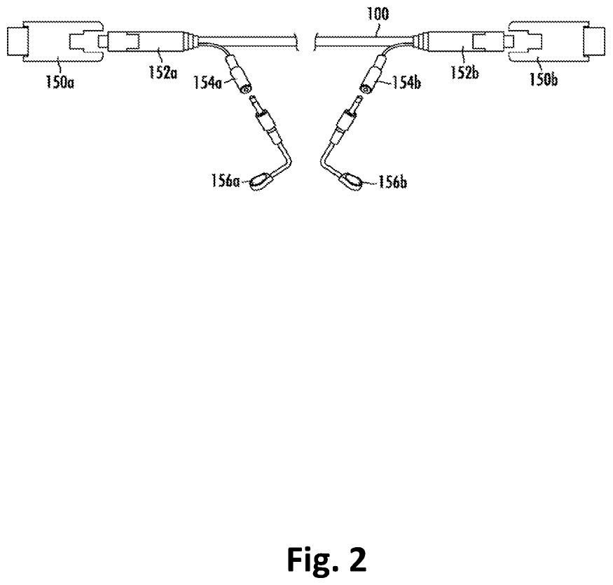

Referring now to FIGS. 1 and 2, a particular aspect of the IRVOF-LT (100) is illustrated as having four fibers and nine electrical wires. The IRVOF-LT includes a jacket (106) and a configuration as follows:
a. IROVF-LT>video IROVF standard cable with 4 fibers+9 electric wires:
Typ app: HDMI/SDI HD/4K/8K and higher+IR remote control−Video IRVOF Cable Extenders,

two wires with shield foil (108, 112) and ground wire (110) for IR infrared uni/bi-directional remote & serial control,

two wires with shield foil (124) and a ground wire (122) for data,

five wires (118, 120, 125) for connection/data/handshaking/power supply/control,

four fibers (102) for video up to 48 Gbps and higher uncompressed for HD/4K/8 k UHD and other/or higher resolutions within a fibers micro tube (104),

anti-stretch Kevlar fibers (116),

global cable shield foil (114).

The IROVF-LT standard cable (100) may include, at a first end, a full-size HDMI adapter (150a), a mini/micro-HDMI connector (152a), and an IR connector (154a) in communication with an IR eye (156a). Similarly, at a second end of the cable (100), may include a full-size HDMI adapter (150b), a mini/micro-HDMI connector (152b), and an IR connector (154b) in communication with an IR eye (156b).

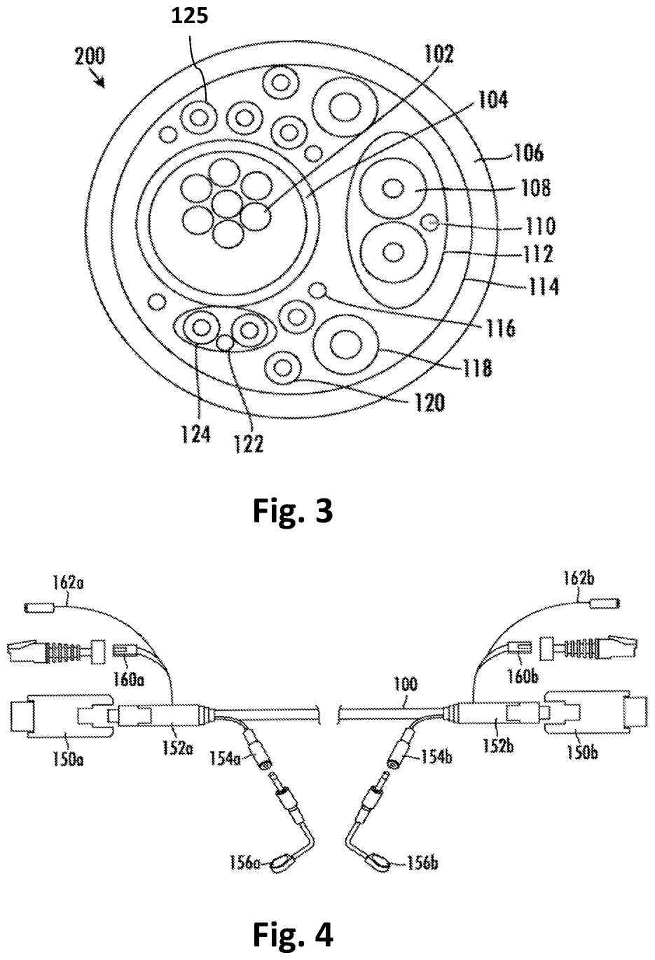

Referring now to FIGS. 3 and 4, a particular aspect of the IRVOF-LTE (200) is illustrated as having seven fibers and twelve electrical wires. The IRVOF-LTE (200) includes a jacket (106) and a configuration as follows:
b. IROVF-LTE>IPTV enhanced IROVF standard cable with seven FIBERS+12 electric wires:
Typ app: HDMI/SDI HD/4K/8K and higher+IR remote control+ETHERNET+TOSLINK−IPTV

IRVOF Cable Extenders,

two wires with shield foil (108, 112) and ground wire (110) for IR infrared uni/bi-directional remote & serial control,

two wires with shield foil (124) and ground wire (122) for data,

five wires (118, 120, 125) for the connection/data/handshaking/power supply/control,

four fibers (102) for video up to 48 Gbps and higher uncompressed for HD/4K/8 k UHD and other or higher resolutions within a fiber's microtube (104),

two fibers (102) for 10/100/1 gigabit−10 gigabit−48 gigabit and higher ethernet connection,

one fiber (102) for TOSLINK audio,

anti-stretch Kevlar fibers (116), and

global cable shield foil (114).

The IROVF-LTE cable (200) may include, at the first end, a full-size HDMI adapter (150a), a mini/micro-HDMI connector (152a), and an IR connector (154a) in communication with an IR eye (156a). Similarly, a second end of the cable (100) may include a full-size HDMI adapter (150b), a mini/micro-HDMI connector (152b), and an IR connector (154b) in communication with an IR eye (156b). In addition, the cable (200) may include an LC Ethernet 10/100/1000 10 Gigabit (4 k/8 k IPTV VR Gaming) connectors (160a, b) and a TOSLINK connector for uncompressed digital audio (162a, b).

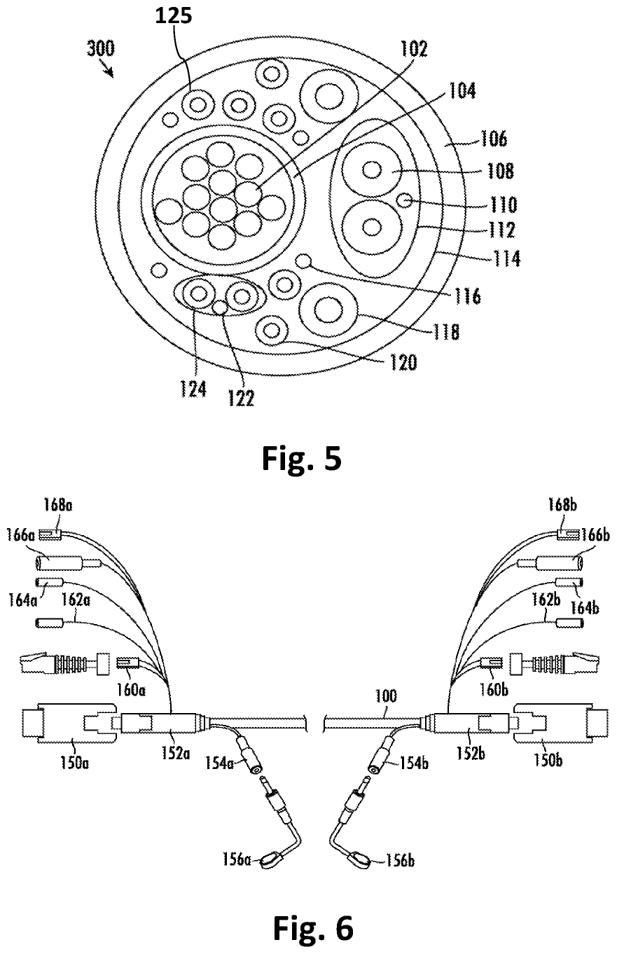

Referring now to FIGS. 5 and 6, a particular aspect of the IRVOF is illustrated as having twelve fibers and twelve electrical wires. The IRVOF-LTX (300) includes a jacket (106) and a configuration as follows:
c. IROVF-LTX>gaming IROVF standard cable with 12 fibers+12 electric wires:

Typ app: HDMI/SDI HD/4K/8K and higher+IR remote control+Ethernet+2 TOSLINK+USB−Gaming IRVOF Cable Extenders,

two wires with shield foil (108, 112) and ground wire (110) for IR infrared uni/bi-directional remote & serial control,

two wires with shield foil (124) and ground wire (122) for data,

five wires (118, 120, 125) for connection/data/handshaking/power supply/control,

four fibers (102) for video up to 48 Gbps and higher uncompressed for HD/4K/8 k UHD and other or higher resolutions within a fibers microtube (104),

two fibers (102) for 10/100/1 gigabit−10 gigabit−48 gigabit and higher ethernet connection,

two fibers (102) for bidirectional TOSLINK audio−one fiber for TOSLINK audio,

four fibers (102) for auxiliary data, control, audio, video, USB, ethernet, split video, and like,

anti-stretch Kevlar fibers (116),

global cable shield foil (114).
see IROVF-LTX suggested color coding and assignment in the figures section.

The IROVF-LTX cable (300) may include, at a first end, a full-size HDMI adapter (150a), a mini/micro-HDMI connector (152a), and an IR connector (154a) in communication with an IR eye (156a). Similarly, at a second end of the cable (100), may include a full-size HDMI adapter (150b), a mini/micro-HDMI connector (152b), and an IR connector (154b) in communication with an IR eye (156b). In addition, the cable (300) may include an LC Ethernet 10/100/1000 10 Gigabit (4 k/8 k IPTV VR Gaming) connectors (160a, b) and a TOSLINK connector for uncompressed digital audio (162a, b). Furthermore, the cable (300) may include a USB (2.0/3.0 and higher) connectors (166a, b) and auxiliary dual fiber LC, 2nd Ethernet, 2nd USB, other busses, home controls, etc. connectors (168a, b).

The IROVF color coding is as follows:
1) MAIN VIDEO LINK>4 FIBERS>RED+GREEN+BLUE+PINK
2) VIDEO LINK CONTROL>7 WIRES>PINK+BROWN+RED+BLACK+WHITE and PURPLE+LIGHT BLUE within shield foil with ground wire
3) IR REMOTE CONTROL>2 WIRES>BLUE+GREY−WITHIN SHIELD FOIL WITH GROUND WIRE
4) MAIN ETHERNET>2 FIBERS>GREY+YELLOW
5) MAIN TOSLINK>1 FIBER>BROWN
6) SECONDARY TOSLINK>1 FIBER>PURPLE
7) MAIN USB>2 FIBER>ORANGE+WHITE
8) AUX FIBER LINK>2 FIBERS>LIGHT BROWN+LIGHT BLUE
9) AUX WIRES>3 WIRES>YELLOW+ORANGE+GREEN

IROVF Licensed manufacturers may follow the above color coding to guarantee inter-compatibility between devices and manufacturers and facilitate on-site installations and parts replacement/servicing.

Disclosed is a unitary signal communication cable that has a first end and a second end that is opposite the first end. The first end has a first infrared eye configured for receiving and reproducing infrared commands. The second end has a second infrared eye configured for receiving and reproducing infrared commands. Several fiber optics extend from the first end to the second end and provide for high-bandwidth data transfer. Several electrical conductor strands extend between the first end and the second end for transmitting data, control signals, commands, and the like. One or more electrical conductors can provide for communicating infrared commands in either direction between the first infrared eye and the second infrared eye. Both the optical fibers and the conductor wires can be shielded to prevent any interferences to either analog or digital signals. The conductor wires and the optical fibers can connect a range of devices, peripherals, and accessories that can be controlled from any end of the unitary signal communication cable. The disclosed unitary signal communication cable allows the creation of a perfect environment for people, where commands can be sent to set the perfect atmosphere: perfect light, perfect climate, perfect sound, and perfect audio video. The disclosed unitary signal communication cable allows for managing curtain motors, HVAC systems, lights, audio-video systems, alarms, and the like home electronics from a single control panel avoiding the clutter of multiple remotes. Moreover, the need to go over to a device for operating it can be avoided as the user can control a device far away, or maybe in a different room while sitting on a sofa. People may not need to scramble around the house and grab different remotes to get the thing done. Devices can be controlled from a single place; thus, commands can be centralized for devices that may be anywhere in the house including a different room or a room on a different floor.

The disclosed unitary signal communication cable can be adapted to include control mechanisms other than infrared. The electric wires can be provided for transmitting different kinds of control signals. Infrared remote control has been the most common and standard, however, the device may use different mechanisms for remote controlling the device, and any such mechanism known to a skilled person is within the scope of the present invention. The combination of optical fibers and conductors can provide compatibility for a range of devices used in homes and offices.

In one implementation, the disclosed unitary signal communication cable can be provided with audio return channel (ARC-e/ARC) functionality. The said functionality can be provided with a shared or dedicating fiber or conductor, the conductor can be copper or silver; moreover, the conductor can be straight or twisted. Preferably, the conductor can be coaxial, such as Twinaxial cabling commercially available that supports Dolby® and AV receiver can drive the loudspeakers. In certain implementations, the audio return channel can be provided through optical fibers.

In one implementation, the disclosed unitary signal communication cable can transmit Wi-Fi mesh commands, commands for alarms, commands to operate security cameras, specific commands for curtain motors, commands for HVAC systems, and the like. The disclosed unitary signal communication cable can include AES/EBU channel, XLR channel, Aux channel, and/or S/PDIF channel. The disclosed unitary signal communication cable can provide connectivity for high-speed and low-speed multimedia data which can be analog or digital. Also, copper or silver conductors or fiber can connect USB-USB-C extension or KVM commands. In certain implementations, the combination of optical fibers and conductors can provide for video data transfer, such as HDMI and ethernet commands. The Ethernet commands control between the source and displays side of the disclosed cable. One or more conducting wires can carry power from source to destination, if some of the peripherals connected, such as extender termination over fiber, need the power to be carried to them.

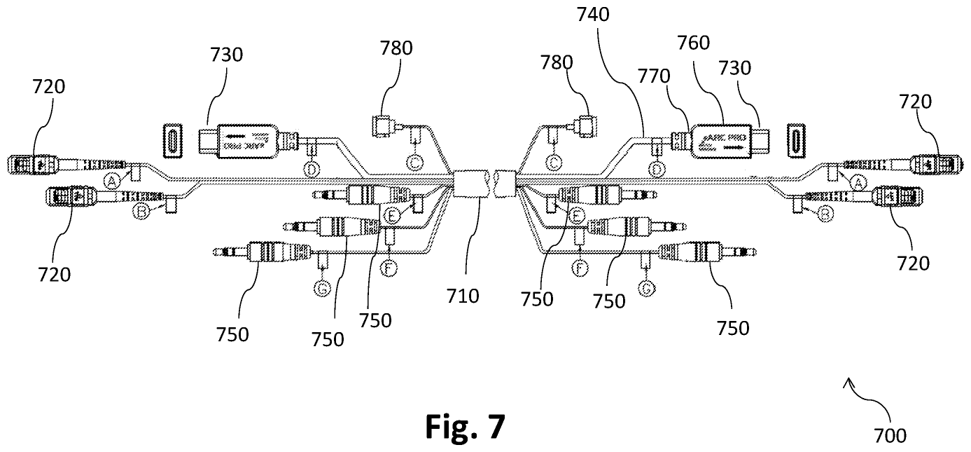

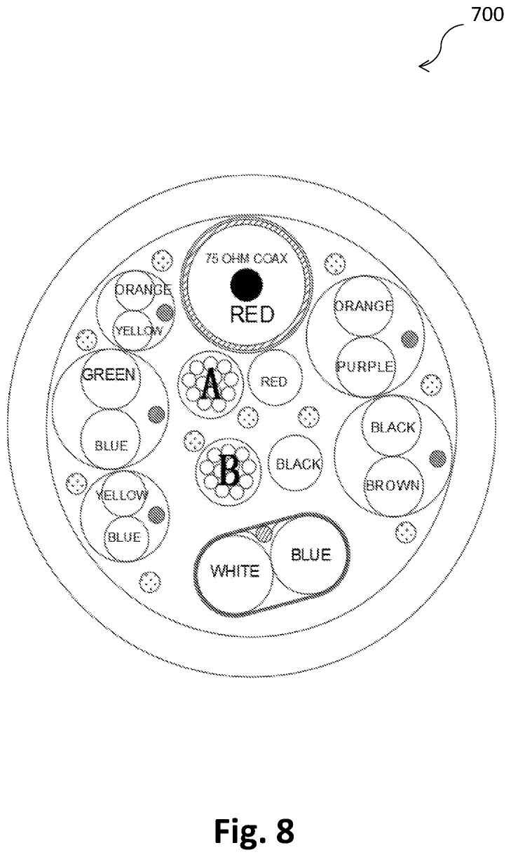

Referring to FIG. 7 shows an exemplary embodiment of the unitary signal communication cable having three Infrared conducting strands, two multi-strand fiber optic terminations, coax termination, and power share+e/ARC signal over USB carried from one end to the opposite end. The e/ARC runs on silver Twinax® and shares power, in this specific example terminated with a USB connector (USB or USBC). FIG. 7 shows an optical fiber cable (OM3-150) 710, MPO female connector 720, USB-3 Type-C male connector 730, heat shrink tubes 740, 3.5 mm stereo plug that can be gold plated 750, PVC 760, and SMA male 75 OHM connector 780. FIG. 8 shows a cross-section view of the unitary signal communication cable 700. The unitary signal communication cable 700 has the HDMI main signal connected to the fiber optic and the power share and e/ARC are connected through the USB. In alternate embodiments, HDMI removable termination can have the power share over the electrical connector, e/ARC over coax, and the main signal over fiber optic. The unitary signal communication cable can have one Ethernet plus, one Infrared control, one multi-strand fiber optic termination, coax termination for e/ARC, and power share over an electric connector.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A unitary signal communication cable, the unitary signal communication cable comprising:
a first end having a first infrared eye configured for receiving and reproducing infrared commands;
a second end opposite the first end, the second end having a second infrared eye configured for receiving and reproducing infrared commands;
a plurality of fiber optics extending from the first end to the second end;
a plurality of first electric wires coupled between the first infrared eye and the second infrared eye, wherein the plurality of first electric wires are configured to communicate commands in either direction between the first infrared eye and the second infrared eye;
a plurality of shielding with a first shielding located around the plurality of fiber optics and a second shielding located around a respective number of the plurality of first electric wires to provide for transportation of any combination of analog and digital signals without interference; and
a plurality of second electrical wires extend between the first end and the second end, wherein the plurality of second electrical wires are configured to transmit control signals other than that of infrared.

2. The unitary signal communication cable of claim 1, wherein the unitary signal communication cable further comprises anti-stretch Kevlar fibers.

3. The unitary signal communication cable of claim 1, wherein the unitary signal communication cable further comprises at least one ground wire.

4. The unitary signal communication cable of claim 1, wherein the unitary signal communication cable further comprises an outer covering to provide for a unitary cable from the first end to the second end.

5. The unitary signal communication cable of claim 1, wherein one or more of the plurality of second electrical wires are configured to transmit ethernet signals.

6. The unitary signal communication cable of claim 5, wherein one or more of the plurality of second electrical wires are configured to connect and control security cameras.

7. The unitary signal communication cable of claim 6, wherein one or more of the plurality of second electrical wires are configured as audio return channel.

8. The unitary signal communication cable of claim 7, wherein one or more of the plurality of second electrical wires are configured to connect and control lights.

9. The unitary signal communication cable of claim 8, wherein one or more of the plurality of second electrical wires are configured to connect and control curtain motors.

10. A method for transmitting data and control signals between devices, the method comprises:
providing a unitary signal communication cable, the unitary signal communication cable comprising:
a first end having a first infrared eye configured for receiving and reproducing infrared commands,
a second end opposite the first end, the second end having a second infrared eye configured for receiving and reproducing infrared commands,
a plurality of fiber optics extending from the first end to the second end,
a plurality of first electric wires coupled between the first infrared eye and the second infrared eye, wherein the plurality of first electric wires are configured to communicate commands in either direction between the first infrared eye and the second infrared eye,
a plurality of shielding with a first shielding located around the plurality of fiber optics and a second shielding located around a respective number of the plurality of first electric wires to provide for transportation of any combination of analog and digital signals without interference, and
a plurality of second electrical wires extend between the first end and the second end, wherein the plurality of second electrical wires are configured to transmit control signals other than that of infrared.

11. The method of claim 10, wherein the unitary signal communication cable further comprises anti-stretch Kevlar fibers.

12. The method of claim 10, wherein the unitary signal communication cable further comprises at least one ground wire.

13. The method of claim 10, wherein the unitary signal communication cable further comprises an outer covering to provide for a unitary cable from the first end to the second end.

14. The method of claim 10, wherein one or more of the plurality of second electrical wires are configured to transmit ethernet signals.

15. The method of claim 14, wherein one or more of the plurality of second electrical wires are configured to connect and control security cameras.

16. The method of claim 15, wherein one or more of the plurality of second electrical wires are configured as audio return channel.

17. The method of claim 16, wherein one or more of the plurality of second electrical wires are configured to connect and control lights.

18. The method of claim 17, wherein one or more of the plurality of second electrical wires are configured to connect and control curtain motors.
